(19) United States
(12) Patent Application Publication
(10) Pub. No.: US 2007/0152814 A1
(43) Pub. Date: Jul. 5, 2007

(54) Systems and methods for autonomous data acquisition, sensor integration and information transmission in a lightweight device

(75) Inventor: Rolf Stefani, West River, MD (US)

Correspondence Address: OLIFF & BERRIDGE, PLC, P.O. BOX 19928, ALEXANDRIA, VA, 22320, US

(73) Assignee: ARINC INC., Annapolis, MD (US)

(21) Appl. No.: 11/319,388

(22) Filed: Dec. 29, 2005

(51) Int. Cl. G08B 1/08; G08B 21/00

(52) U.S. Cl. 340/539.22; 340/870.16

(57) ABSTRACT

A lightweight autonomous device is provided that can (1) determine its own positional information, (2) detect, via sensors with which it communicates, a position of a moving or stationary target, (3) calculate a relative position of that target to the device's own known position, and (4) transmit data regarding the target to a local or remote receiving station where the data can be interpreted and displayed. The disclosed device may employ global positioning satellites for position-keeping, detect and collect information from individual sensors regarding targets, calculate position information regarding targets by comparing sensor information with the device's known position, and communicate information to a compatible receiving system at a remote location, as well as performing local processing on the information. The receiving system may display the information to provide a situational awareness overview to a user to coordinate or control personnel activities and/or vehicular movements based on the displayed information.

### BACKGROUND

This disclosure is directed to systems and methods for implementing, in a single lightweight device, capabilities for data acquisition, sensor integration and information transmission.

A variety of sensors and sensor arrays are conventionally employed to detect, track and/or report information regarding myriad static and dynamic targets and/or points of interest (“targets”) in the vicinity of the sensors and sensor arrays. Examples of such sensor employment include, for example, detecting aircraft movement, vehicular movement and/or personnel movement, and/or isolating, for example, individual static ground targets based on some detectable characteristic. These detectable characteristics may include, for example, radar signatures, radio emissions, infrared signatures, heat signatures, sensed motion, chemical emissions, biological emissions, radiological hazard emissions, visual signatures, switch or contact states or any other like characteristic by which a sensor or sensor array can detect a target.

A local tactical display of detected targets is generally provided in the vicinity of a specific sensor or sensor array to enhance a user's situational awareness. The collection and processing devices are, however, often large and cumbersome requiring significant power and cooling sources be provided. Additionally, there are scenarios in which an ability to remotely view a tactical picture or a situational awareness overview developed around a sensor array is beneficial. Large, cumbersome, often radar-based detection and transmission systems, generally with a man-in-the-loop, conventionally fill these requirements with the attendant drawbacks discussed above, particularly when a remote transmission capability is incorporated into the system. In many applications, conventional systems, such as, for example, manned or unmanned radar detection, analysis and reporting systems, are too costly, large, cumbersome or otherwise not suitable to the application. One such example is detailed in the following paragraphs.

Unmanned aerial vehicles (UAVs) are being built and deployed at a significant rate in response to military, law enforcement and other agency or individual surveillance requirements. By virtue of the UAV not having a pilot on board able to detect close aerial traffic, or to effect maneuvers to avoid collision based on visual- or sensor-detected proximity to other aircraft, there have been an increasing number of serious safety-related incidents, including near and actual midair collisions between UAVs and conventional aircraft operating in close proximity to one another in both controlled and uncontrolled airspace. Such a traffic detection and avoidance problem presents itself almost daily in areas of heavy UAV deployment such as, for example, in military missions flown in forward theaters of operation. Future UAV deployment is envisioned to fulfill growing military, law enforcement and other specific aerial surveillance and monitoring requirements such as, for example, border patrol surveillance and pipeline monitoring. As such, a need to provide a remote operator with a vehicle-centric situational awareness picture to detect targets and/or avoid hazards such as those described above would be not only beneficial, but will likely prove a necessary factor in the eventual acceptance and/or full integration of UAVs in, for example, domestic airspace.

### SUMMARY

The above describes one exemplary scenario in which a capability to provide an increased vehicle- or device-centric tactical and/or situational awareness picture would prove beneficial. Myriad other scenarios also exist. For instance, all manner of law enforcement surveillance, stationary/fixed, or moving, for example, on foot, from a vehicle, or from the air may, be enhanced by an ability to closely monitor man-carried and/or vehicle-mounted sensor arrays to detect noise, heat, movement, or other characteristics for, for example, crowd and/or riot control, fire detection and suppression and/or hazardous material exposure detection and avoidance.

It would be advantageous to provide a lightweight and low-cost autonomous device that can (1) output information regarding its own positional information, (2) detect, via one or a plurality of sensors with which it communicates, a position of a moving or stationary target based on some identifiable characteristic of the target to which the sensor is accommodated, (3) identify a relative position of that target to the device's own known position, and (4) transmit data regarding the detected target to a local or remote receiving station where the data can be automatically interpreted and displayed for any beneficial purpose, such as, for example to enhance situational awareness of a user or to coordinate vehicle or personnel movements.

In various exemplary embodiments, disclosed systems and methods are particularly useful for developing a device-centric situational awareness overview based on the device indicating where it is geographically, detecting and collecting information from one or more individual sensors, calculating information regarding static and/or moving targets by correlating acquired data or sensor information to the device's own position and communicating such integrated information to a compatible receiving station at a local or remote location that is capable of displaying the device's geographic position and the positions of the detected targets. In this disclosure, when reference is made to a device indicating its own position or performing its own position calculation, it should be understood that the device may perform position-based calculations on-board, or may transmit raw position data to a receiving node where such calculations may be performed.

In various exemplary embodiments, disclosed systems and methods may provide a mission-specific device designed to be lightweight and low-cost with a primary function to act as an autonomous sensor integration and information transmission device. The device may output information indicating its own position by employing global positioning satellite, or other position-keeping, information. The device may detect and collect information from an array of individual sensors regarding one or more targets to which the sensors may be directed, and characteristics of which the sensors are designed to detect. The device may calculate relative or absolute position information regarding detected static and/or moving targets by comparing acquired data or sensor information with the device's own position. The device may communicate, via, for example, wireless data-link like protocols, detected, collected, and/or calculated information to a compatible receiving system at a local or remote location via, for example, a satellite transceiver. The receiving system may facilitate display, for example, in appropriate graphical manner, of received information to provide a situational awareness overview to a receiving user. Such a receiving user may communicate instructions to the device, personnel or host vehicles, to coordinate or otherwise control, for example, personnel activities and/or vehicular movements based on the displayed situational awareness overview.

In various exemplary embodiments, disclosed systems and methods are intended to be lightweight and autonomous in order to be, for example, easily man-carried or able to be integrated into vehicles with very strict payload size and weight constraints for any carried devices, such as, for example, unmanned aerial vehicles (UAVs). The device may be installed in virtually any surface or aerial vehicle, or man-carried, to enhance surveillance and provide information necessary to develop a situational awareness overview at a local or remote receiving node having a compatible receiver and information display device.

In exemplary embodiments, disclosed systems and methods may provide a device that includes at least a sensor interface, a GPS receiver, a satellite transceiver, power distribution circuitry, and a processor/controller, preferably all housed in a single lightweight enclosure.

In various exemplary embodiments, disclosed systems and methods may be able to receive data input from an array of local sensors which may include, but are not limited to, global positioning satellite (GPS) systems and, for example, aircraft transponder systems and/or airframe-mounted Traffic Alert and Collision Avoidance Systems (TCAS), particularly those including transponder mode S and/or Automatic Dependent Surveillance-Broadcast (ADS-B) capabilities. Sensor integration capabilities may further include an ability to receive sensed data from, for example, radiation sensors, heat sensors, visual sensors, motion sensors, chemical sensors, biological sensors, radiological sensors, microwave sensors, RF sensors, external switch and contact closure or any other such sensor capability.

It should be appreciated that, although thus far the discussion of sensors has been focused on external sensors for detecting some specified characteristic regarding a target outside, or at some range from, the disclosed device, the exemplary systems and methods should not be considered so limited. In addition to external target information type gathering sensors, local sensors, monitors and/or data sources may also provide input to the device via an appropriate sensor interface or otherwise by a compatible data interface located within the device. Such local sensors may include, for example, biometric sensors when the device is man-carried, in order that information regarding the status of the individual carrying the device may be transmitted to the local or remote receiving node. Further, it should be appreciated that the term vehicle, as discussed herein, although sometimes modified by terms such as “aerial” or “surface,” should not be construed to be limited to any specific type of vehicle or conveyance, or movement in any specific environment. Virtually any airborne, surface (land or sea) or sub-surface vehicle, generally powered, as the term “vehicle” may be most broadly construed, is contemplated to be able to receive a device according to the disclosed systems and methods. Once such a device is installed, or otherwise carried, in a vehicle, local monitoring systems of vehicle performance and/or performance parameters regarding installed systems within the vehicle may also be provided to the device via an appropriate sensor interface compatible with an array of monitoring devices such that gathered information regarding vehicle status or, for example, engine status (such as engine performance parameters), may be communicated to a local or remote receiving node.

These and other features and advantages of the disclosed systems and methods are described in, or apparent from, the following detailed description of various exemplary embodiments.

### BRIEF DESCRIPTION OF THE DRAWINGS

Various exemplary embodiments of disclosed systems and methods will be described, in detail, with reference to the following figures, wherein:

FIG. 1A illustrates an exemplary communication system within which the systems and methods according to this disclosure may be incorporated;

FIG. 1B illustrates several exemplary targets which sensors that may communicate with exemplary devices according to this disclosure may be used to detect;

FIG. 2 illustrates a block diagram of an exemplary embodiment of an autonomous data acquisition, sensor integration and information transmission device according to this disclosure; and

FIG. 3 illustrates a block diagram of an exemplary remote receiving node for receiving, processing and displaying a situational awareness overview based on information provided by exemplary systems and methods according to this disclosure.

### DETAILED DESCRIPTION OF EMBODIMENTS

The following description of various exemplary embodiments of disclosed systems and methods will describe an exemplary autonomous device including a transceiver system for external communication that: (1) may employ information from global positioning system (GPS) satellites, or other position keeping information, to output information regarding the device's own location; (2) may detect and collect information from one or more individual sensors, monitors or data sources; (3) may output information regarding positions, and optionally status or characteristics, of static and/or moving targets, based on acquired sensor information, and also based on the device's own location information, when the device's own location information has been calculated within the device; and (4) may communicate detected, collected, and/or calculated information to a compatible receiving system at a local or remote location where the received information may be displayed in an appropriate graphical manner to enhance situational awareness of a receiving user regarding, for example, the status of the device, the status of the platform on which the device is carried, and detected static or moving targets in the vicinity of the device.

In the following discussion, specific reference may be made to inclusion of a disclosed device to enhance situational awareness and collision avoidance with respect to UAVs. Reference to a UAV-based scenario for application of the disclosed device is provided for clarity and ease of understanding of certain of the considerations that may motivate the design of the device, e.g., specific payload size and weight constraints to the host vehicle. This disclosure, however, should not be in any way read as limited to such an application for the disclosed device. In fact, the systems and methods according to this disclosure may be equally applicable in any remote surveillance and/or monitoring application. Such applications may include those where a device may be positioned in a fixed or semi-fixed location, or is intended to be mobile, for example, man-carried, or hosted within a movable vehicle of virtually any description. Typical applications may include any use where an ability to receive sensor information or other data, reference that sensor information to a geographic position of the device, or simply to time and date information that may be internally-generated or externally communicated to the device from some source, and to communicate collated positional data, gathered sensor data or other information to a local or remote receiving node may be advantageous.

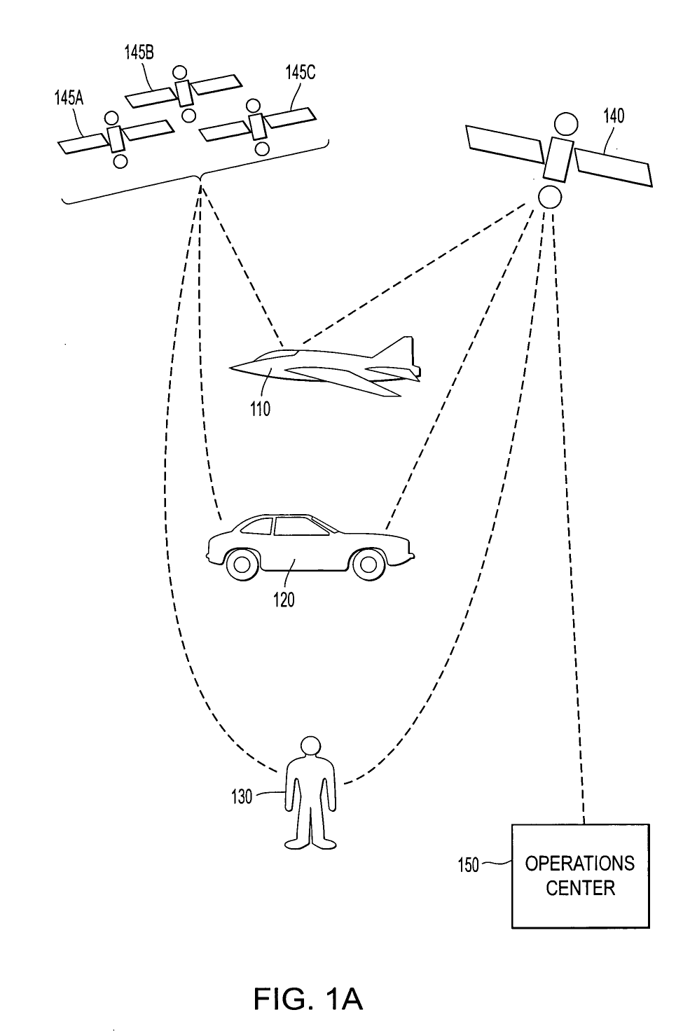

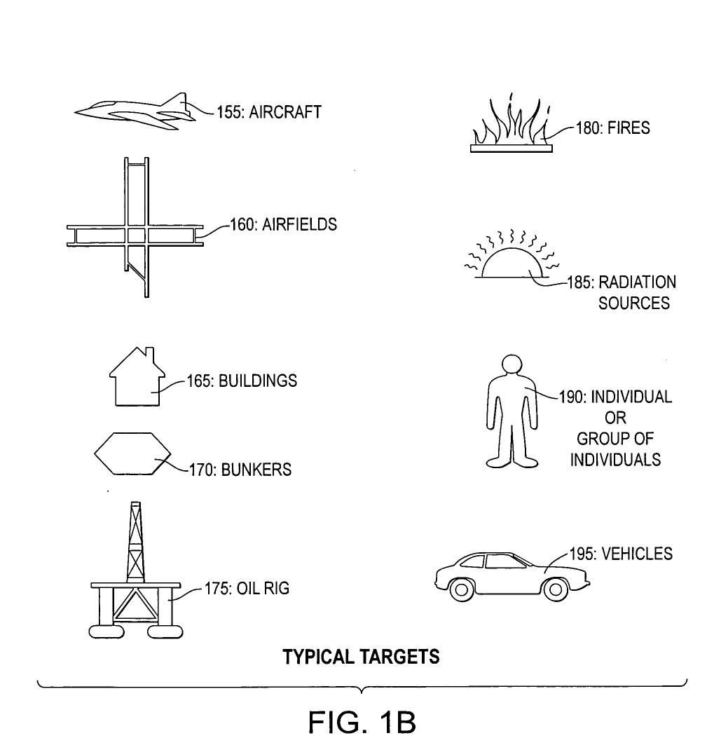

FIG. 1A illustrates an exemplary communication system within which the systems and methods according to this disclosure may be incorporated.

As shown in FIG. 1, the host communication system may include one or more airborne surveillance vehicles 110, one or more surface (land or water) surveillance vehicles 120, and/or one or more individuals 130, each equipped with, or otherwise carrying, a device according to this disclosure. Aerial surveillance vehicles 110 may include both manned and unmanned aerial platforms. Surface surveillance vehicles 120 may include, but are not limited to, military and/or civilian manned and/or unmanned vehicles used for surface surveillance on land or water, and are considered to include sub-surface vehicles as well. In each case, whether in an aerial vehicle 110, a surface vehicle 120 or carried by an individual 130, an exemplary device for implementing the systems and methods according to this disclosure may be usable to output information regarding its own position by communicating with a constellation of global positioning system (GPS) satellites, shown in exemplary manner as 145A-C. Individual sensors, as will be discussed below, may be usable to detect and obtain position information of individual or multiple static or moving targets based on detectable characteristics of those targets. Contemplated targets according to this disclosure include, but are not limited to (as shown in FIG. 1B) target aircraft 155, target airfields 160, target buildings 165, target bunkers 170, target oil rigs 175 or other industrial structures, target fires 180 or other natural disaster indicia, target radiation sources 185 or chemical/biological/radiological hazard areas, target individuals 190 and target vehicles 195 as may be able to be sensed based on the characteristics of the target and the capabilities of the particular sensor in use.

In various exemplary embodiments, as will be discussed below, position information regarding any sensed static or moving target, such as those enumerated above, may be sensed and referenced to the position of the surveillance platform or individual carrying a device based on the device outputting information regarding its own position with reference to the GPS satellite constellation 145A-C. Internal processing may be accomplished within the device, again as will be discussed in further detail below, and this processed information, or otherwise raw, unprocessed data may be provided via a satellite communications link to a communications satellite 140 and ultimately to a remote receiving node such as, for example, an exemplary operations center 150. Within the exemplary operations center 150, as will be discussed in further detail below, information received from one or more devices may be processed to develop a tactical picture or “situational awareness overview.” The information provided by the device via the above-identified satellite link 140 may be deciphered, processed and appropriately displayed to the benefit of a receiving user. The receiving user may then, in turn, based on the situational awareness overview with which the receiving user is provided, communicate or otherwise effect personnel and/or vehicular movements as the presented situational awareness overview may warrant.

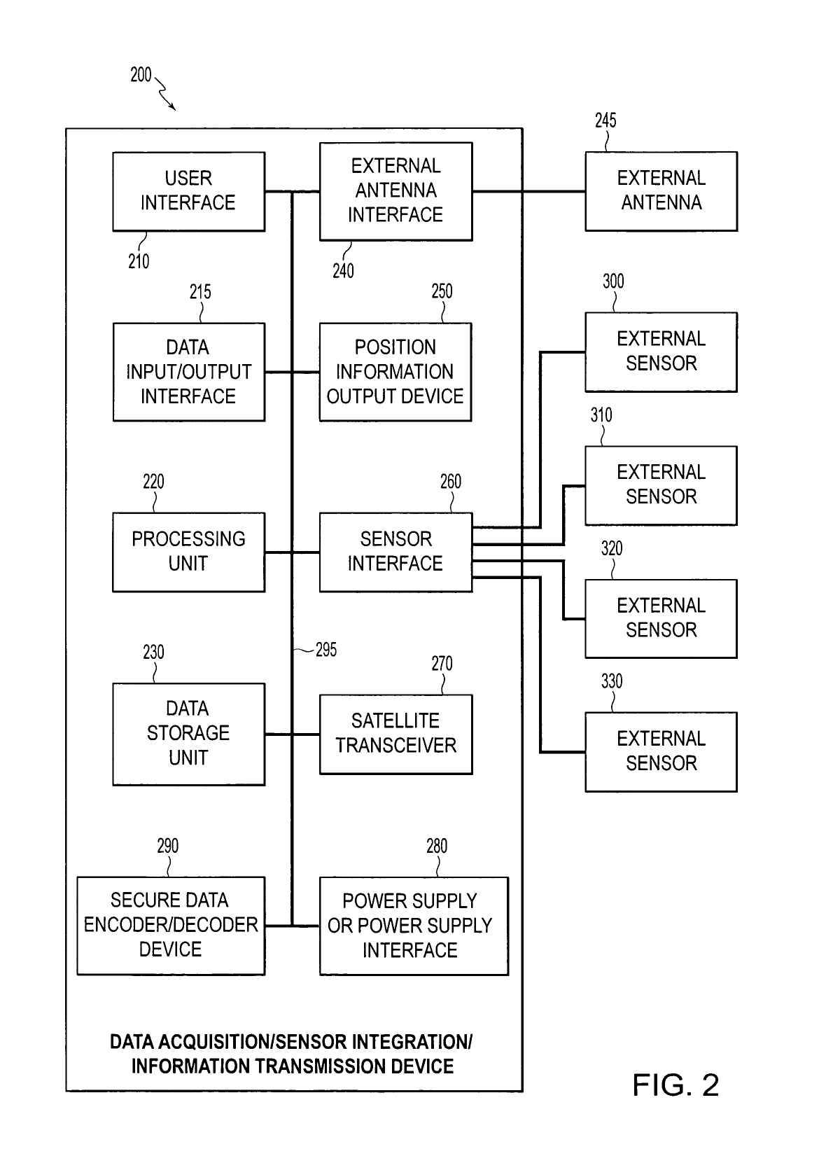

FIG. 2 illustrates a block diagram of an exemplary embodiment of an autonomous data acquisition, sensor integration and information transmission device 200 according to this disclosure. As shown in FIG. 2, an exemplary autonomous lightweight data acquisition, sensor integration and information transmission device 200 (“device 200”) may include a user interface 210, a data input/output interface 215, a processing unit 220, a data storage unit 230, an external antenna interface 240 (for connection to one or more combination or specific-use external antennas 245), a position information output device 250, a sensor interface 260, a satellite transceiver 270, an internal power supply or power supply interface 280, and a secure data encoder/decoder device 290, all interconnected via a data/control bus 295.

It should be appreciated that although depicted as separate individual elements, any of the depicted individual units or devices may be combinable with other individual units or devices as combined units or devices within the disclosed lightweight enclosure. Further, while envisioned as a hardwired data/control bus 295, any data communication path by which data and control inputs may be exchanged between individual units or devices, and/or combination units or devices, within the exemplary device 200 is envisioned. Such data communication paths may include individual wired and/or wireless and/or optical communications connections, or any combinations of such connections, between communicating elements.

In various exemplary embodiments, the device 200 may be a single lightweight enclosure. Exemplary dimensions for the device are that no linear measurement (length, width or height) is greater than 5 inches and weight is less than 2 pounds.

In various exemplary embodiments, a user interface 210, when included, may afford a user an opportunity to directly communicate with the device 200, or to communicate with one or more remote receiving nodes via the device 200.

In various exemplary embodiments, the device 200 may substantially continuously determine its own position, or output raw data regarding its position, employing the position information output device 250, that may include, for example, a global positioning satellite as the (GPS) transceiver that receives and processes information from the global positioning satellite constellation (depicted in exemplary manner in FIG. 1). The device 200 may receive sensor input from one or more sensors (depicted in exemplary manner as elements 300/310/320/330) via a sensor interface 260. Exemplary sensors will be described in greater detail below. Received sensor information input to the device 200 via the sensor interface 260 may be communicated to the processing unit 220 in which computations and correlations of received sensor data, for example, range and azimuth data concerning a sensed target, may be undertaken in order that received sensor information may be associated with a specific geographic position from which a specific sensor-received emission and/or characteristic may have emanated. It will be appreciated that a portion of this processing could be performed at a remote receiving node such as the exemplary operations center 150 depicted in FIG. 1.

In various exemplary embodiments, the sensor information may not need to be geographically correlated but rather simply assimilated and/or catalogued based on a date/time reference that may be available from the GPS satellite constellation via a GPS transceiver, or otherwise. In this regard, the device 200 may be available to record and process information regarding, for example, operating characteristics of an engine or other installed systems of a host vehicle within which the device 200 is mounted or otherwise carried. Alternatively, the device 200 may receive biometric data regarding an individual that is operating the device 200 in a man-carried mode via, for example, any manner of biometric data sensors that may communicate with the device via the sensor interface 260.

To this point, all discussion regarding data and/or other sensor information input to the device 200 has focused on the information being made available to the device 200 via the sensor interface 260 from one or more sensors 300/310/320/330. However, input to the device 200 is not to be construed as being limited to this single path. For example, as discussed above, a user in contact with the device 200 may provide input to the device 200 via the user interface 210. Additionally, when provided, any manner of data monitor and/or electronic data-providing device may be in electronic communication with, the device 200 by any manner of, for example, wired, wireless or optical data exchange connection by which data may be transferred from such a data monitor or data-providing device to the device 200 via the data input/output interface 215. As indicated above, such received data may be beneficially associated with a geographic position of the device 200 and/or a time and date of reception. The processing unit 220 of the device 200 may collate data received via the user interface 210, the sensor interface 260 and/or the data input/output interface 215 with information on device position and/or date and time. Accurate time and date information may be provided to the system via, for example, GPS input.

In various exemplary embodiments, the processing unit 220 may be usable also to format (1) data regarding own-position of the device 200; (2) received sensor information or other data obtained from one or more sensors or devices via the sensor interface 260 or the data input/output interface 215, either as raw data or correlated position and/or time data based on a correlation with position and time/date information; and (3) other instructions as a user may input via the user interface 210. Formatted raw or processed data may be communicated to the satellite transceiver 270 for satellite transmission from the device 200 to, for example, a remote receiving node. Raw or processed data may also be stored in a data storage unit 230 prior to transmission or may be stored for, for example, a timed duration or duration of an event to be later downloaded via, for example, the data input/output interface 215 to any purpose for which archiving and later download, review and/or processing of such data may be undertaken as beneficial.

In various exemplary embodiments, one or more external antenna interfaces 240 may be available to accommodate data transmission and reception between the device 200 and one or more external general purpose and/or specific-purpose antennas 245 as may be beneficially employed as sensors, and/or to facilitate GPS, other satellite or other data communications to or from the device 200.

In various exemplary embodiments, a secure data encoder/decoder device 290 may be available to, for example, encrypt the data received by the device 200, and optionally processed by the processing unit 220, prior to passing that data to the satellite transceiver 270 for transmission via satellite communications to the remote receiving node. Such a secure data encoder/decoder device 290 may be included to enhance secure communications between the device 200 and any external communications link with which the device 200 may communicate.

In various exemplary embodiments, power may be supplied to the device via a power supply interface 280 from, for example, a separate power source in a host vehicle, or a separately carried battery pack or other power source. Alternatively, the power supply 280 may be internal to the device 200 including, but not limited to, batteries, solar panels, or other now known or later developed capabilities by which power could be autonomously supplied to the individual units or devices constituting the device 200.

In various exemplary embodiments, the satellite transceiver 270 may be a device whose sole purpose is to provide a satellite communication path between the device 200 and any remote receiving node with which the device 200 may be capable of communicating via satellite communications.

As indicated above, the sensor interface 260 of the device 200 may communicate with one or more sensors for detecting individual characteristics regarding external targets, whether mobile or fixed, or for monitoring own vehicle or user status. An example of an available sensor array and typical employment of that sensor array will now be discussed in exemplary, non-limiting, manner.

In various exemplary embodiments, related to a specific scenario regarding employment of the exemplary device 200 in a UAV, the sensor information input through the sensor interface 260 may be derived from a Traffic Alert and Collision Avoidance System (TCAS) sensor 300 mounted on the UAV. Some such systems may include low-cost devices that are available to provide, for example, indications of traffic within a specific proximity of the vehicle, thereby alerting a controlling user to effect tactical maneuvers of the UAV to avoid collisions. Such systems may detect other aircraft transponder signals, for example, in their vicinity and simply decode signal strength and directionality based on known averages, while other such systems may decode transponder mode “S” and/or ABS-B messages of target aircraft in order to extract position information from those messages. The TCAS system itself when employed as a sensor 300 may process position data of a target vehicle and processed target range and azimuth data may be provided to the device 200 via the sensor interface 260. Alternatively, TCAS information sensed by a TCAS sensing system as a sensor 300 may be provided via the sensor interface 260 to the device 200 such that the processing unit 220 of the device 200 may calculate a geographic reference of the target vehicle to the host vehicle. In this case, target vehicles likely include aircraft and/or other UAVs, and the data may be used to establish a proximity of the target vehicle and to assess, for example, a hazard level associated with the target vehicle's proximity. In this manner, the device 200 may be able to process information concerning traffic in the vicinity of a host vehicle by calculating, for example, geographical relationships of all potential target vehicles to the device's host vehicle based on positional information available to the device 200 as determined by the position information output device 250, such as, for example, via a GPS transceiver. Information obtained from the processing unit 220 may be formatted and communicated, for example, to the satellite transceiver 270 to be further communicated via satellite transmission to a remote receiving node.

It should be appreciated that, although described as a separate TCAS system as sensor 300, a TCAS circuit board (not shown) may be included within the device 200. Any required connections, for example, to a TCAS antenna array, as a specific-purpose antenna 245, may be facilitated through the external antenna interface 240 in the device 200. It should be further appreciated that the external antenna interface 240 may be available to interface with one or more combined purpose, multi-purpose or single-purpose external antennas such as, for example, those that may be required to support TCAS, GPS and/or satellite communications connectivity, such antennas being compatibly mounted on, for example, a host vehicle.

It should be appreciated that the UAV scenario, discussed in detail above is only provided as an illustrative example of where an exemplary device 200 may be beneficially employed.

Other sensors to which either a sensor interface 260 or a data input/output interface 215 may be connected to receive data from, and, in certain circumstances, transmit data to, external sensors, monitors or other electronic information devices are not limited to any specific device, sensor, monitor and/or application for employment of any specific device, monitor or sensor. Examples of other data sources, in addition to the myriad sensors mentioned otherwise throughout this disclosure, for providing information to or receiving information from the device 200 may include, for example, an Electronic Flight Bag (EFB). An EFB could use device-derived GPS information to drive, for example, a moving map type display of an application resident within the EFB. An overlay over such a moving map may display, for example, received TCAS information. Airborne situational awareness in a manned aerial vehicle within which the device may be installed or otherwise carried may thus be enhanced. Additionally, an EFB communicating with the device 200 may facilitate sending and receiving e-mail like messages by connecting the EFB to the device 200 via the data input/output interface 215, or otherwise, in order that satellite communication of information held within the EFB may be facilitated via the satellite transceiver 270 of the device 200. Other data such as may be available can be communicated to EFB type devices as well, e.g., position reporting information that could be relayed to a remote receiving node via the device 200.

In various exemplary embodiments, other sensors may include one or more sensors 300/310/320/330 that provide input to the device 200 via the sensor interface 260. Such sensors may include, but are not limited to, for example, radiation sensors, RF sensors, visual sensors, motion sensors or any other like sensor array available to detect a specific characteristic of a target object, or even a geographic reference point exhibiting some sensor-measurable characteristic. Further, data interface may be provided via the sensor interface 260 and/or the data input/output interface 215, as discussed above.

It should be appreciated that the processor 220 and the data storage unit 230 of the device 200 may provide sufficient data storage and processor capacity to facilitate the inclusion of additional functionalities to be implemented within the device 200 itself. Software applications to facilitate, for example, such enhanced functionalities may be pre-stored, or communicated to the device 200 via the data input/output interface 215 or the user interface 210.

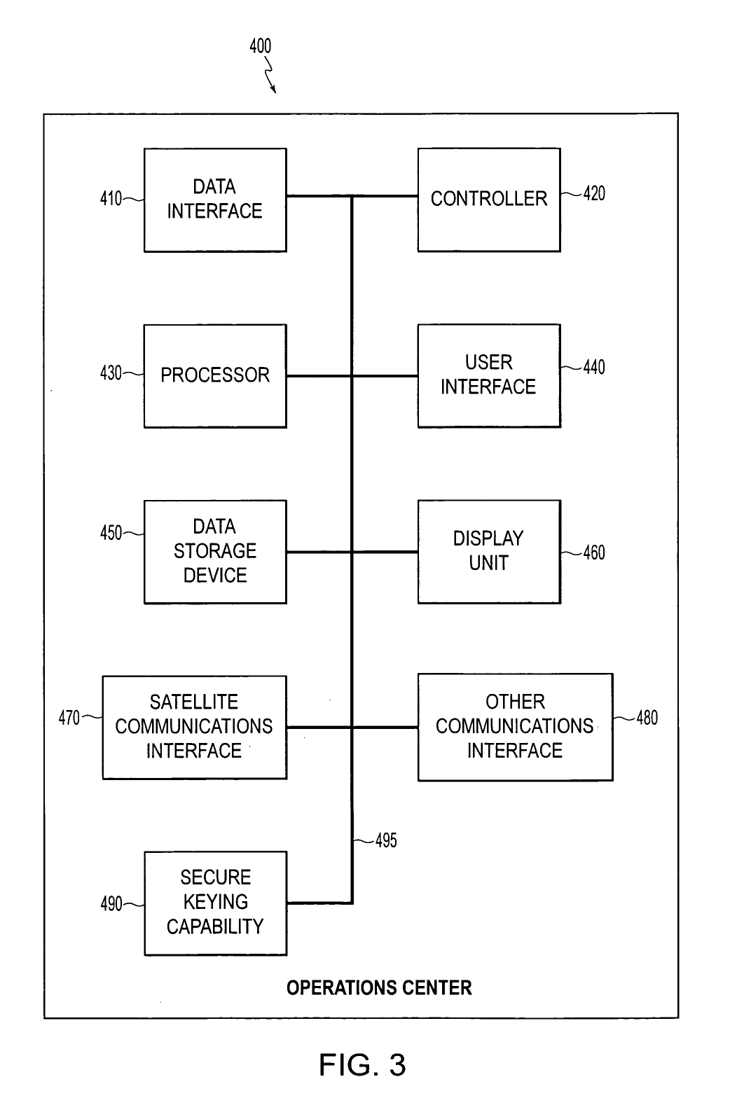

FIG. 3 illustrates a block diagram of an exemplary remote receiving node 400 for receiving, processing and displaying information provided via some communications link, for example, a satellite communications link, with the device 200 depicted in FIG. 2 in order to display a tactical picture and/or situational awareness overview based on that information. The exemplary remote receiving node 400 shown in FIG. 3 will be referred to as an Operations Center 400 for ease of understanding where such a processed and developed tactical display may be beneficially employed. Such an Operations Center 400 may include a data interface 410, a controller 420, a processor 430, a user interface 440, at least one data storage device 450, a display unit 460, a satellite communications interface 470, at least one other communications interface 480, and a secure keying capability 490, all interconnected with a data/control bus, or network connection, or set of connections, depicted as element 495.

In various exemplary embodiments, the individual elements constituting the Operations Center 400 may include each of the depicted elements as a single stand-alone element, or these elements may be combined in varying combinations. Data interface and/or information exchange between individual elements or combinations of elements may be facilitated by any manner by which data exchange is possible between such elements. Data exchange links may include, for example, any manner of wired, wireless or optical communications capabilities, alone or in varying combinations, as to be beneficially employed to provide data communications interface and data exchange between the individually depicted elements of the Operations Center 400.

Exemplary data received from a remote device may include device identification, positional reporting, raw or calculated data regarding detected targets, status messages regarding status of the device and/or the host vehicle within which the device may be carried, and/or other like information.

In exemplary embodiments, the data interface 410, the controller 420, the processor 430, and the user interface 440 may together make up an information exchange unit.

In exemplary embodiments, the display unit 460 may be employed to generate, based on information received from one or more device, a pseudo-radar, radar-like, or synthetic computer generated display representing a geographically-referenced center point that defines, for example, a location of the device in a fixed or moving manner with pseudo-radar or synthetic targets represented in a sector, hemispheric or global presentation surrounding the geographically-referenced center point representing the device.

In exemplary embodiments, a user may have at the user's disposal, as part of the display unit 460, or otherwise, a series of settable messages, notes, cautions and/or warnings regarding received sensor information received from the device. Where applicable, the settings may be manipulated through the user interface 440 and information may be otherwise exchanged with the device as may be input through the user interface 440, or otherwise.

In various exemplary embodiments, it is contemplated that the display unit 460 will automatically display the processed received information which may be received via the satellite communications interface 470, processed via the processor 430, optionally stored in the data storage device 450, and displayed on the display unit 460. It should be appreciated, however, that the user may manipulate the display via controls provided to this purpose in the user interface 440, or otherwise, to cause the display on the display unit 460 to be manually update and/or modified. The device may be updated and/or reconfigured remotely as well via the described communications paths.

In various exemplary embodiments, in order to facilitate secure transmission and reception of data to and from the Operations Center 400, a secure keying capability 490 may be provided.

In various exemplary embodiments, based on an interpretation of a presented situational awareness overview displayed on the display unit 460, a user may be able to send messages, or control data, back to the device and/or otherwise to the vehicle or individual carrying the device, in order to, for example, effect personnel and/or vehicular movement toward a point of interest or away from a hazardous situation detected through interpretation of the received and displayed sensor or other information from the device.

It should be appreciated that the ground-based communication and data display capability may be reasonably unrestricted regarding any ability to send and receive and/or otherwise interpret device status, host vehicle or individual carrier status, sensor status, sensed data, geographic data, configuration and parameter settings, and additionally a capability to remotely turn a device on or off. In this manner, the parameters of the device and/or the vehicle within which the device may be carried may be reset in real time.

It should be appreciated that the user interface 440 may, for example, provide programmatic access to the device, or any form of data input and output may be available via a sensor interface of the device being compatible for data transmission and reception to and from, for example, any manner of portable electronic data storage and display device of which an EFB is a specific example. Alternatively, a separate data input/output connection may be provided for such connectivity.

In various exemplary embodiments, one or more data storage units 230 shown in FIG. 2 or data storage device 450 shown in FIG. 3 may be available to provide storage for (1) data collected by the device, (2) sensor data interpreted by the device, (3) processed data to be communicated to at least one remote receiving node from the device and/or (4) one or more software operating applications, routines, algorithms and/or subroutines for effecting the operation of the device or the receiving node.

Any data storage contemplated for exemplary embodiment of the disclosed device and/or receiving node may be implemented using any appropriate combination of alterable memory or fixed memory. The alterable memory, whether volatile or non-volatile, may be implemented using any one or more of static core dynamic RAM, a miniaturized internal disk drive, with associated disk-type medium, a hard drive, a flash memory or any other like memory medium and/or device. Similarly, fixed memory can be implemented using any one or more of ROM, PROM, EPROM, EEPROM, or compatible internal disk drive, or any other like memory storage medium and/or device.

It should be appreciated that given the required inputs, the processing outlined above, particularly for the processing unit in the disclosed device, may be implemented through software algorithms, hardware or firmware circuits, or any combination of software, hardware and/or firmware control and processing elements. This is particularly true regarding implementation of processing for correlating received sensor data with received own-position data, and formatting such data for transmission.

While exemplary embodiments have been described above for the disclosed device, the exemplary embodiments, and the variations thereof, should be viewed as illustrative, and not limiting. Various modifications, substitutes, or the like are possible to implement the systems and methods according to this disclosure.

What is claimed is:

1. A data acquisition device, comprising:
a position information output device that outputs information regarding the device's geographic position in real time;
a sensor interface that the device uses to at least one of communicate with or receive data from one or more sensors, the sensors being usable to detect at least one characteristic of at least one static target or moving target;
a processor that processes received sensor data to correlate the sensor data to at least one of the determined geographic position of the device in real time or a time and date of sensor data reception; and
an external communication device that automatically communicates data from the device to at least one remote receiving node.

2. The device of claim 1, wherein the position information output device, the sensor interface, the processor and the external communications device are all housed in a single enclosure with no linear dimension (height, width or length) greater than 5 inches and a weight of less than 2 pounds.

3. The device of claim 1, wherein the position information output device comprises a global positioning satellite transceiver.

4. The device of claim 1, wherein the external communication device comprises a satellite transceiver to facilitate satellite communication of data.

5. The device of claim 1, further comprising a user interface that allows a user to communicate directly with the device.

6. The device of claim 1, further comprising a data storage unit for storing at least one of device-derived data or data received by the device.

7. The device of claim 1, further comprising a secure data encoder/decoder device for facilitating secure communications via the external communication device.

8. The device of claim 1, further comprising at least one of an internal power supply or a power supply interface.

9. The device of claim 1, wherein the one or more sensors with which the sensor interface communicates comprise at least one of an aircraft transponder interrogator or a Traffic Alert and Collision Avoidance System (TCAS).

10. The device of claim 1, wherein the one or more sensors with which the sensor interface communicates comprise sensors for detecting one or more of radar signatures, radio emissions, infrared signatures, motion, chemical emissions, biological emissions, radiological hazard emissions, or visual signatures.

11. The device of claim 1, wherein the device can be carried by a user and when carried by a user, the device can receive information regarding the status of the user from sensors, comprising biometric sensors attached to the user, via the sensor interface or otherwise via a data input/output interface.

12. The device of claim 1,
wherein the device can be at least one of carried or otherwise mounted in a host vehicle, the host vehicle being manned or unmanned, the host vehicle being powered, and the host vehicle comprising at least one of an aerial vehicle, a surface land vehicle, a surface water vehicle, or a sub-surface water vehicle, and
wherein the device can receive information regarding the status of the host vehicle from sensors comprising at least one of monitors or other data sources attached to or otherwise in communication with at least one to the host vehicle, discrete components of the host vehicle or other systems carried by the host vehicle via the sensor interface or otherwise via a data input/output interface.

13. The device of claim 12, wherein the host vehicle is an unmanned aerial vehicle (UAV).

14. A system for enhancing situational awareness of a user, comprising:
at least one device according to claim 1; and
at least one remote receiving node for communicating with the device via satellite communications,
wherein the at least one remote receiving node receives, processes and displays data received from the at least one device, and facilitates communication of information back to at least one of the at least one device, an individual carrying the at least one device, or a host vehicle within which the at least one device is carried, the communicated information being provided by a user via a user interface at the at least one remote receiving node based on the user's interpretation of the displayed data from the at least one device.

15. A method for enhancing situational awareness of a user, comprising:
employing at least one device according to claim 1 to provide data to at least one remote receiving node;
receiving, at the at least one remote receiving node, data transmitted from the at least one device;
processing and displaying the received data at the at least one remote receiving node;
receiving from a user instructions via a user interface at the at least one remote receiving node based on the user's interpretation of the processed and displayed data; and
transmitting the received user instructions from the at least one remote receiving node to the at least one device, an individual carrying the at least one device, or a host vehicle within which the at least one device is carried.

16. The method of claim 15, wherein the user's interpretation of the displayed data includes an automatically remotely computed interpretation.

17. The method of claim 15, wherein user instructions are internally generated within the system.
